(19) United States
(12) Patent Application Publication
(10) Pub. No.: US 2023/0242818 A1
(43) Pub. Date: Aug. 3, 2023

(54) FILM AND LAMINATE

(71) Applicant: FUJIFILM Corporation, Tokyo (JP)

(72) Inventors: Miyoko HARA, Kanagawa (JP); Yasuyuki SASADA, Kanagawa (JP)

(73) Assignee: FUJIFILM Corporation, Tokyo (JP)

(21) Appl. No.: 18/154,876

(22) Filed: Jan. 16, 2023

(30) Foreign Application Priority Data
Jan. 31, 2022 (JP) 2022-013111

(51) Int. Cl. C09K 19/38; C08K 7/28; C08K 3/36; C08L 77/12

(52) U.S. Cl. CPC C09K 19/3814; C08K 7/28; C08K 3/36; C08L 77/12; C08L 2203/16

(57) ABSTRACT

Provided are a film which includes at least an a liquid crystal polymer and a filler, and has a melting calorie equal to or greater than 0.5 J/g; a laminate which includes at least the film and a metal layer or a metal wire which is disposed on at least one surface of the film; and applications of the film.

### CROSS REFERENCE TO RELATED APPLICATIONS

The present application claims priority under 35 U.S.C. § 119 to Japanese Patent Application No. 2022-013111 filed on Jan. 31, 2022. The above application is hereby expressly incorporated by reference, in its entirety, into the present application.

### BACKGROUND OF THE INVENTION

### 1. Field of the Invention

The present disclosure relates to a film and a laminate.

### 2. Description of the Related Art

In recent years, a frequency that is used in communication equipment tends to be extremely high. To suppress a transmission loss in a high frequency band, it has been required to decrease a specific dielectric constant and a dielectric loss tangent of an insulation material that is used in a circuit board.

In the related art, while polyimide is often used as the insulation material that is used in the circuit board, a liquid crystal polymer that has high heat resistance and low water absorption and is small in transmission loss in the high frequency band is attracting attention.

For example, JP2020-026474A describes a liquid crystalline polyester film that contains at least liquid crystalline polyester, in which, in a case where a first alignment degree is set to an alignment degree with respect to a first direction parallel to a main surface of the liquid crystalline polyester film, and a second alignment degree is set to an alignment degree with respect to a second direction parallel to the main surface and perpendicular to the first direction, a first alignment degree/second alignment degree that is a ratio of the first alignment degree and the second alignment degree is equal to or greater than 0.95 and equal to or less than 1.04, and a third alignment degree of the liquid crystalline polyester that is measured by a wide angle X-ray scattering method in a direction parallel to the main surface is equal to or greater than 60.0%.

### SUMMARY OF THE INVENTION

An object of an embodiment of the present invention is to provide a film and a laminate that are excellent in strength and have a low dielectric loss tangent compared to the related art.

Means for attaining the above-described object includes the following aspects.

<1> A film comprising: a liquid crystal polymer, and a filler, in which the film has a melting calorie equal to or greater than 0.5 J/g.

<2> The film according to <1>, in which the liquid crystal polymer contains aromatic polyester amide.

<3> The film according to <2>, in which the aromatic polyester amide contains a constitutional unit represented by Formula 1, a constitutional unit represented by Formula 2, and a constitutional unit represented by Formula 3,

with respect to a total content of the constitutional unit represented by Formula 1, the constitutional unit represented by Formula 2, and the constitutional unit represented by Formula 3,

a content of the constitutional unit represented by Formula 1 is 30% by mol to 80% by mol,

a content of the constitutional unit represented by Formula 2 is 10% by mol to 35% by mol, and

a content of the constitutional unit represented by Formula 3 is 10% by mol to 35% by mol,

—O—Ar¹—CO— Formula 1

—CO—Ar²—CO— Formula 2

—NH—Ar³—O— Formula 3

in Formula 1 to Formula 3, Ar¹, Ar², and Ar³ each independently represent a phenylene group, a naphthylene group, or a biphenylylene group.

<4> The film according to any one of <1> to <3>, in which the filler includes an inorganic filler containing at least one selected from the group consisting of boron nitride, titanium dioxide, and silicon dioxide.

<5> The film according to any one of <1> to <4>, in which the filler includes an organic filler containing at least one selected from the group consisting of liquid crystalline polyester, polytetrafluoroethylene, and polyethylene.

<6> The film according to any one of <1> to <5>, in which the filler contains hollow particles.

<7> The film according to any one of <1> to <6>, in which the filler contains liquid crystal polymer particles, silica particles, or glass hollow particles.

<8> The film according to <7>, in which the liquid crystal polymer particles include liquid crystal polymer particles with a surface subjected to oxidation treatment.

<9> The film according to any one of <1> to <8>, in which a content of the filler is 30% by volume to 80% by volume with respect to a total volume of the film.

<10> A laminate comprising the film according to any one of <1> to <9>, and a metal layer or a metal wire, disposed on at least one surface of the film.

According to the embodiment of the present invention, a film and a laminate that are excellent in strength and have a low dielectric loss tangent compared to the related art are provided.

### DESCRIPTION OF THE PREFERRED EMBODIMENTS

Hereinafter, the content of the present disclosure will be described in detail. The description of the constituent elements described below will be made based on a representative embodiment of the present disclosure, but the present disclosure is not limited to such an embodiment.

In the present specification, “to” indicating a numerical range is used in a meaning including numerical values described before and after “to” as a lower limit value and an upper limit value.

In numerical ranges described in stages in the present disclosure, an upper limit value and a lower limit value described in one numerical range may be substituted with an upper limit value and a lower limit value of another numerical range described in another stage. In the numerical ranges described in the present disclosure, an upper limit value and a lower limit value of the numerical ranges may be substituted with values shown in examples.

In a case where substitution or unsubstitution is not noted in regard to the notation of a group (atomic group) in the present specification, the group includes not only a group having no substituent but also a group having a substituent. For example, “alkyl group” denotes not only an alkyl group (unsubstituted alkyl group) having no substituent but also an alkyl group (substituted alkyl group) having a substituent.

In the present disclosure, a combination of two or more preferred aspects is a more preferred aspect.

A weight-average molecular weight (Mw) and a number-average molecular weight (Mn) in the present disclosure are molecular weights in terms of polystyrene used as a standard substance, which are detected by a solvent pentafluorophenol (PFP)/chloroform=½ (mass ratio) and a differential refractometer using gel permeation chromatography (GPC) analyzer using TSKgel SuperHM-H (product name manufactured by Tosoh Corporation) as a column, unless otherwise specified.

Film

A film of the present disclosure includes a liquid crystal polymer and a filler, and has a melting calorie equal to or greater than 0.5 J/g.

The present inventors have conducted intensive studies and have found that the above-described configuration is made, whereby it is possible to provide a film that is excellent in strength and has a low dielectric loss tangent compared to the related art.

A detailed mechanism with which the above-described effect is obtained is unclear, but is presumed as follows.

Since the film of the present disclosure includes the filler, it is considered that the film is excellent in strength. Since the melting calorie is equal to or greater than 0.5 J/g, it is considered that a crystallization amount in the film is large, and mobility of a non-crystallized portion decreases, such that the dielectric loss tangent decreases.

On the other hand, it has been understood that the film described in JP2020-026474A does not include a filler, and breakage, break, or the like may occur in the film during a manufacturing process of processing the film to a product, such as a circuit board, or a product after processing.

Liquid Crystal Polymer

The film of the present disclosure contains a liquid crystal polymer (LCP).

In the present disclosure, the kind of the liquid crystal polymer is not particularly limited, and a known liquid crystal polymer can be used.

The liquid crystal polymer may be a thermotropic liquid crystal polymer that shows a liquid crystalline property in a molten state or may be a lyotropic liquid crystal polymer that shows a liquid crystalline property in a solution state. In a case where the liquid crystal polymer is a thermotropic liquid crystal polymer, the liquid crystal polymer is preferably a liquid crystal polymer that is molten at a temperature equal to or lower than 450° C.

Examples of the liquid crystal polymer include liquid crystalline polyester, liquid crystalline polyester amide in which an amide bond is introduced into liquid crystalline polyester, liquid crystalline polyester ether in which an ether bond is introduced into liquid crystalline polyester, and liquid crystalline polyester carbonate in which a carbonate bond is introduced into liquid crystalline polyester.

From a viewpoint of the liquid crystalline property, the liquid crystal polymer is preferably a polymer having an aromatic ring, and more preferably aromatic polyester or aromatic polyester amide.

The liquid crystal polymer may be a polymer in which a bond derived from an isocyanate, such as an imide bond, a carbodiimide bond, or an isocyanurate bond, is introduced into aromatic polyester or aromatic polyester amide.

The liquid crystal polymer is preferably a fully aromatic liquid crystal polymer that uses an aromatic compound as a source monomer alone.

Examples of the liquid crystal polymer include the following liquid crystal polymers.

1) Substance obtained by polycondensing (i) aromatic hydroxy carboxylic acid, (ii) aromatic dicarboxylic acid, (iii) at least one kind of compound selected from the group consisting of aromatic diol, aromatic hydroxyamine, and aromatic diamine.

2) Substance obtained by polycondensing a plurality of kinds of aromatic hydroxy carboxylic acid.

3) Substance obtained by polycondensing (i) aromatic dicarboxylic acid, and (ii) at least one kind of compound selected from the group consisting of aromatic diol, aromatic hydroxyamine, and aromatic diamine.

4) Substance obtained by polycondensing (i) polyester, such as polyethylene terephthalate, and (ii) aromatic hydroxy carboxylic acid.

Here, aromatic hydroxy carboxylic acid, aromatic dicarboxylic acid, aromatic diol, aromatic hydroxyamine, and aromatic diamine may be each independently substituted with a polycondensable derivative.

For example, aromatic hydroxy carboxylic acid and aromatic dicarboxylic acid can be substituted with aromatic hydroxy carboxylic acid ester and aromatic dicarboxylic acid ester by converting a carboxy group into an alkoxycarbonyl group or an aryloxycarbonyl group.

Aromatic hydroxy carboxylic acid and aromatic dicarboxylic acid can be substituted with aromatic hydroxy carboxylic acid halide and aromatic dicarboxylic acid halide by converting a carboxy group into a haloformyl group.

Aromatic hydroxy carboxylic acid and aromatic dicarboxylic acid can be substituted with aromatic hydroxy carboxylic acid anhydride and aromatic dicarboxylic acid anhydride by converting a carboxy group into an acyloxycarbonyl group.

Examples of a polymerizable derivative of a compound having a hydroxy group, such as aromatic hydroxy carboxylic acid, aromatic diol, or aromatic hydroxyamine, include a substance (acylated substance) obtained by acylating the hydroxy group to convert the hydroxy group into an acyloxy group.

For example, aromatic hydroxy carboxylic acid, aromatic diol, and aromatic hydroxyamine can be each substituted with an acylated substance by acylating a hydroxy group to convert the hydroxy group into an acyloxy group.

Examples of a polymerizable derivative of a compound having an amino group, such as aromatic hydroxyamine or aromatic diamine, include a substance (acylated substance) obtained by acylating the amino group to convert the amino group into an acylamino group.

For example, aromatic hydroxyamine and aromatic diamine can be each substituted with an acylated substance by acylating an amino group to convert the amino group into acylamino group.

The liquid crystal polymer is preferably a crystalline polymer (for example, aromatic polyester amide described below). The liquid crystal polymer included in the film has crystalline, whereby the dielectric loss tangent further decreases.

The crystalline polymer refers to a polymer having a clear endothermic peak, not a stepwise endothermic amount changed, in differential scanning calorimetry (DSC). Specifically, for example, this means that a half-width of an endothermic peak in measuring at a temperature increase rate 10° C./minute is within 10° C. A polymer in which a half-width exceeds 10° C. and a polymer in which a clear endothermic peak is not recognized are distinguished as an amorphous polymer from a crystalline polymer.

A melting point of the liquid crystal polymer is preferably equal to or higher than 250° C., more preferably 250° C. to 350° C., and still more preferably 260° C. to 330° C.

The melting point is measured using a differential scanning calorimetry apparatus.

The liquid crystal polymer has a melting calorie preferably equal to or greater than 0.5 J/g, more preferably equal to or greater than 2.2 J/g, and still more preferably equal to or greater than 4.0 J/g. An upper limit value of the melting calorie is not particularly limited, and is, for example, 10.0 J/g. A measurement method of the melting calorie is the same as a measurement method of a melting calorie of a film described below.

The weight-average molecular weight of the liquid crystal polymer is preferably equal to or less than 1,000,000, more preferably 3,000 to 300,000, still more preferably 5,000 to 100,000, and particularly preferably 5,000 to 30,000.

The liquid crystal polymer preferably includes aromatic polyester amide from a viewpoint of further decreasing the dielectric loss tangent. Aromatic polyester amide is resin having at least one aromatic ring and having an ester bond and an amide bond. Aromatic polyester amide included in a resin layer is preferably fully aromatic polyester amide among the substances from a viewpoint of heat resistance.

Aromatic polyester amide preferably contains a constitutional unit represented by Formula 1, a constitutional unit represented by Formula 2, and a constitutional unit represented by Formula 3.

—O—Ar¹—CO— Formula 1

—CO—Ar²—CO— Formula 2

—NH—Ar³—O— Formula 3

In Formula 1 to Formula 3, Ar¹, Ar², and Ar³ each independently represent a phenylene group, a naphthylene group, or a biphenylylene group.

Hereinafter, the constitutional unit represented by Formula 1 and the like are also referred to as a “unit 1” and the like.

The unit 1 can be introduced, for example, using aromatic hydroxy carboxylic acid as a raw material.

The unit 2 can be introduced, for example, using aromatic dicarboxylic acid as a raw material.

The unit 3 can be introduced, for example, using aromatic hydroxylamine as a raw material.

Here, aromatic hydroxy carboxylic acid, aromatic dicarboxylic acid, aromatic diol, and aromatic hydroxylamine may be each independently substituted with a polycondensable derivative.

For example, aromatic hydroxy carboxylic acid and aromatic dicarboxylic acid can be substituted with aromatic hydroxy carboxylic acid ester and aromatic dicarboxylic acid ester by converting a carboxy group into an alkoxycarbonyl group or an aryloxycarbonyl group.

Aromatic hydroxy carboxylic acid and aromatic dicarboxylic acid can be substituted with aromatic hydroxy carboxylic acid halide and aromatic dicarboxylic acid halide by converting a carboxy group into a haloformyl group.

Aromatic hydroxy carboxylic acid and aromatic dicarboxylic acid can be substituted with aromatic hydroxy carboxylic acid anhydride and aromatic dicarboxylic acid anhydride by converting a carboxy group into an acyloxycarbonyl group.

Examples of a polycondensable derivative of a compound having a hydroxy group, such as aromatic hydroxy carboxylic acid or aromatic hydroxyamine, include a substance (acylated substance) obtained by acylating the hydroxy group to convert the hydroxy group into an acyloxy group.

For example, aromatic hydroxy carboxylic acid and aromatic hydroxylamine can be each substituted with an acylated substance by acylating a hydroxy group to convert the hydroxy group into an acyloxy group.

An example of a polycondensable derivative of aromatic hydroxylamine is a substance (acylated substance) obtained by acylating an amino group to convert the amino group into an acylamino group.

For example, aromatic hydroxyamine can be substituted with an acylated substance by acylating an amino group to convert the amino group into an acylamino group.

In Formula 1, Ar¹ is preferably a p-phenylene group, a 2,6-naphthylene group, or a 4,4′-biphenylylene group, and more preferably a 2,6-naphthylene group.

In a case where Ar¹ is a p-phenylene group, the unit 1 is, for example, a constitutional unit derived from p-hydroxybenzoic acid.

In a case where Ar¹ is a 2,6-naphthylene group, the unit 1 is, for example, a constitutional unit derived from 6-hydroxy-2-naphthoic acid.

In a case where Ar¹ is a 4,4′-biphenylylene group, the unit 1 is, for example, a constitutional unit derived from 4′-hydroxy-4-biphenylcarboxylic acid.

In Formula 2, Ar² is preferably a p-phenylene group, an m-phenylene group, or a 2,6-naphthylene group, and more preferably an m-phenylene group.

In a case where Ar² is a p-phenylene group, the unit 2 is, for example, a constitutional unit derived from terephthalic acid.

In a case where Ar² is an m-phenylene group, the unit 2 is, for example, a constitutional unit derived from isophthalic acid.

In a case where Ar² is a 2,6-naphthylene group, the unit 2 is, for example, a constitutional unit derived from 2,6-naphthalenedicarboxylic acid.

In Formula 3, Ar³ is preferably a p-phenylene group or a 4,4′-biphenylylene group, and more preferably a p-phenylene group.

In a case where Ar³ is a p-phenylene group, the unit 3 is, for example, a constitutional unit derived from p-aminophenol.

In a case where Ar³ is a 4,4′-biphenylylene group, the unit 3 is, for example, a constitutional unit derived from 4-amino-4′-hydroxybiphenyl.

With respect to a total content of the unit 1, the unit 2, and the unit 3, a content of the unit 1 is preferably equal to or greater than 30% by mol, a content of the unit 2 is preferably equal to or less than 35% by mol, and a content of the unit 3 is preferably equal to or less than 35% by mol.

The content of the unit 1 is preferably 30% by mol to 80% by mol, more preferably 30% by mol to 60% by mol, and particularly preferably 30% by mol to 40% by mol, with respect to the total content of the unit 1, the unit 2, and the unit 3.

The content of the unit 2 is preferably 10% by mol to 35% by mol, more preferably 20% by mol to 35% by mol, and particularly preferably 30% by mol to 35% by mol, with respect to the total content of the unit 1, the unit 2, and the unit 3.

The content of the unit 3 is preferably 10% by mol to 35% by mol, more preferably 20% by mol to 35% by mol, and particularly preferably 30% by mol to 35% by mol, with respect to the total content of the unit 1, the unit 2, and the unit 3.

The total content of the constitutional units is a value obtained by totaling a substance amount (mol) of each constitutional unit. The substance amount of each constitutional unit is calculated by dividing a mass of each constitutional unit constituting aromatic polyester amide by a formula weight of each constitutional unit.

A ratio of the content of the unit 2 and the content of the unit 3 is preferably 0.9/1 to 1/0.9, more preferably 0.95/1 to 1/0.95, and still more preferably 0.98/1 to 1/0.98 in a case of being represented by [content of unit 2]/[the content of the unit 3] (mol/mol).

Aromatic polyester amide may have two kinds or more of the unit 1 to the unit 3 each independently. Alternatively, aromatic polyester amide may have other constitutional units other than the unit 1 to the unit 3. A content of other constitutional units is preferably equal to or less than 10% by mol, and more preferably equal to or less than 5% by mol, with respect to a total content of all constitutional units.

Aromatic polyester amide is preferably produced by subjecting a source monomer corresponding to the constitutional unit constituting the aromatic polyester amide to melt polymerization.

The film of the present disclosure may contain only one kind of aromatic polyester amide or may contain two kinds or more of aromatic polyester amide.

A content of aromatic polyester amide is preferably equal to or greater than 50% by mass, more preferably equal to or greater than 70% by mass, and still more preferably equal to or greater than 90% by mass, with respect to a total amount of the film. An upper limit value of the content of aromatic polyester amide is not particularly limited, and may be 100% by mass.

Filler

The film according to the present disclosure includes a filler.

The filler may be particulate or fibrous, and may be an inorganic filler or an organic filler.

As the inorganic filler, a known inorganic filler can be used.

Examples of a material of the inorganic filler include boron nitride (BN), aluminum oxide (Al₂O₃), aluminum nitride (AlN), titanium dioxide (TiO₂), silicon dioxide (SiO₂), barium titanate, strontium titanate, aluminum hydroxide, calcium carbonate, and a material including two kinds or more thereof.

From a viewpoint of decreasing the dielectric loss tangent of the film, the inorganic filler preferably includes at least one kind selected from the group consisting of boron nitride, titanium dioxide, and silicon dioxide, and is more preferably a material (so-called silica particles) including silicon dioxide.

Alternatively, the inorganic filler may be hollow particles. As a hollow inorganic filler, hollow particles (glass hollow particles) including silicon dioxide are preferably used. An example of hollow particles is a glass bubbles series (for example, glass bubbles S60HS) manufactured by 3M Japan Limited.

The inorganic filler is preferably silica particles that are solid particles including silicon dioxide or glass hollow particles that are hollow particles including silicon dioxide.

From a viewpoint of a thermal expansion coefficient and adhesiveness to metal, an average particle diameter of the inorganic filler is preferably 5 nm to 40 μm, more preferably 1 μm to 35 μm, still more preferably 5 μm to 35 and particularly preferably 10 μm to 35 μm. In a case where particles or fibers are flat, the average particle diameter indicates a length in a short side direction.

The average particle diameter of the inorganic filler is a particle diameter (D50) in a case where volume accumulation from a small diameter side is 50% in a volume-based particle size distribution. D50 can be measured using a scanning electron microscope (SEM).

As the organic filler, a known organic filler can be used.

Examples of a material of the organic filler include polyethylene, polystyrene, urea-formalin filler, polyester, cellulose, acrylic resin, fluororesin, cured epoxy resin, crosslinked benzoguanamine resin, crosslinked acrylic resin, a liquid crystal polymer (LCP), and a material including two kinds or more thereof.

From a viewpoint of decreasing the dielectric loss tangent of the film, the organic filler preferably includes at least one selected from the group consisting of a liquid crystal polymer, fluororesin, and polyethylene, more preferably includes at least one kind selected from the group consisting of liquid crystalline polyester, polytetrafluoroethylene, and polyethylene, and still more preferably includes liquid crystalline polyester.

The liquid crystal polymer that is a kind of the organic filler is liquid crystal polymer particles and is distinguished from the liquid crystal polymer included in the film.

Here, the organic filler (also referred to as liquid crystal polymer particles) including the liquid crystal polymer can be produced, for example, by polymerizing the liquid crystal polymer and grinding the liquid crystal polymer into powder by a grinder or the like.

Alternatively, the organic filler may be fibrous, such as nanofibers, or may be hollow resin particles.

From a viewpoint of a thermal expansion coefficient and adhesiveness to metal, an average particle diameter of the organic filler is preferably 5 nm to 20 μm, more preferably 1 μm to 20 μm, still more preferably 5 μm to 15 μm, and particularly preferably 10 μm to 15 μm.

The average particle diameter of the organic filler is a particle diameter (D50) in a case where volume accumulation from a small diameter side is 50% in a volume-based particle size distribution. D50 can be measured using a scanning electron microscope (SEM).

From a viewpoint of decreasing the dielectric loss tangent of the film, the filler preferably contains hollow particles.

In particular, from a viewpoint of decreasing the dielectric loss tangent of the film, the filler more preferably contains liquid crystal polymer particles, silica particles, or glass hollow particles.

From a viewpoint of improving breaking elongation of the film, the liquid crystal polymer particles preferably include liquid crystal polymer particles with a surface subjected to oxidation treatment.

A production method of the liquid crystal polymer particles with the surface subjected to the oxidation treatment is not particularly limited, and preferably includes an oxidation treatment step of oxidizing the surface of the liquid crystal polymer particles.

The oxidation treatment step preferably includes a step of oxidizing the surface of the liquid crystal polymer particles using an oxidizing agent, and more preferably includes a step of bringing the liquid crystal polymer particles and the oxidizing agent into contact with each other in an aqueous solution to oxidize the surface of the liquid crystal polymer particles.

pH of the aqueous solution is not particularly limited as long as the liquid crystal polymer particles can be oxidized, and is preferably equal to or greater than 8, more preferably equal to or greater than 12, and still more preferably equal to or greater than 13. An upper limit value of pH of the aqueous solution is not particularly limited, and is, for example, 14.

A time for which the liquid crystal polymer particles and the oxidizing agent are brought into contact with each other in the aqueous solution is preferably 0.1 hours to 24 hours, more preferably 0.5 hours to 10 hours, and still more preferably 1.5 hours to 6 hours.

A temperature of the aqueous solution in bringing the liquid crystal polymer particles and the oxidizing agent into contact with each other is preferably 1° C. to 95° C., more preferably 25° C. to 80° C., and still more preferably 45° C. to 65° C.

A method for bringing the liquid crystal polymer particles and the oxidizing agent into contact with each other in the aqueous solution is not limited, and examples of the method include a method for mixing the liquid crystal polymer particles and the oxidizing agent using a grinder or a cracking machine, such as a rocking mill, a bead mill, a ball mill, a Henschel Mixer, a jet mill, a star-burst, or a paint conditioner, a method for bringing the liquid crystal polymer particles and the oxidizing agent into contact with each other while stirring using a mechanical stirrer, such as a three-one motor, or a magnetic stirrer, and a method for bringing the liquid crystal polymer particles and the oxidizing agent into contact with each other while circulating an oxidizing agent aqueous solution including the oxidizing agent and the like in a cartridge filled with the liquid crystal polymer particles by a pump.

The particles subjected to the oxidation treatment are preferably taken out from the aqueous solution after the liquid crystal polymer particles and the oxidizing agent are brought into contact with each other in the aqueous solution.

A method for taking out the particles subjected to the oxidation treatment from the aqueous solution is not particularly limited, and a known method can be used. An example of the method is a method for filtering the aqueous solution and sorting the particles subjected to the oxidation treatment as a filtered substance.

The particles subjected to the oxidation treatment are preferably washed by water, an organic solvent, or the like after being taken out.

In the oxidation treatment step, the oxidizing agent is preferably used.

The aqueous solution preferably contains the oxidizing agent.

The oxidizing agent is not limited, and examples of the oxidizing agent include persulfate, such as sodium persulfate, potassium persulfate, and ammonium persulfate; nitrate, such as ceric ammonium nitrate, sodium nitrate, and ammonium nitrate; peroxide, such as hydrogen peroxide and tert-butylhydroperoxide; manganese compounds, such as potassium permanganate and manganese dioxide; chromium compounds, such as potassium chromate and potassium dichromate; hypervalent iodine compounds, such as potassium periodate and sodium periodate; quinone compounds, such as p-benzoquinone, 1,2-naphthoquinone, anthraquinone, and chloranil; an amine oxide compound, such as N-methylmorpholine N-oxide, a salt of halogen oxoacid, such as sodium hypochlorite and sodium chlorite, and a double salt (OXONE manufactured by DuPont) consisting of potassium peroxymonosulfate/potassium hydrogensulfate/potassium sulphate.

From a viewpoint of oxidizability, dispersibility, and tensile strength, the oxidizing agent preferably contains persulfate, and is more preferably persulfate.

From a viewpoint of oxidizability, the oxidizing agent preferably contains at least one compound selected from the group consisting of sodium persulfate, potassium persulfate, ammonium persulfate, hydrogen peroxide, potassium permanganate, sodium hypochlorite, cerium ammonium nitrate, potassium chromate, potassium dichromate, and a double salt consisting of potassium peroxymonosulfate/potassium hydrogensulfate/potassium sulphate, more preferably contains at least one compound selected from the group consisting of sodium persulfate, potassium persulfate, ammonium persulfate, hydrogen peroxide, sodium hypochlorite, cerium ammonium nitrate, and a double salt consisting of potassium peroxymonosulfate/potassium hydrogensulfate/potassium sulphate, and particularly preferably contains at least one compound selected from the group consisting of sodium persulfate, potassium persulfate, and ammonium persulfate.

To support the action of the oxidizing agent, a catalyst may be used separately from the oxidizing agent. Examples of the catalyst include a divalent iron compound (FeSO₄ and the like) and a trivalent iron compound.

Each of the oxidizing agent and the catalyst may be hydrate.

From a viewpoint of oxidizability, a standard oxidation-reduction potential of the oxidizing agent is preferably equal to or greater than 0.30 V, more preferably equal to or greater than 1.50 V, and still more preferably equal to or greater than 1.70 V. An upper limit of the standard oxidation-reduction potential of the oxidizing agent is not particularly limited, and is, for example, preferably equal to or less than 4.00 V, and more preferably equal to or less than 2.50 V.

The standard oxidation-reduction potential is based on a standard hydrogen electrode.

A content of the oxidizing agent in the aqueous solution is preferably 0.05 parts by mass to 20 parts by mass, more preferably 0.1 parts by mass to 20 parts by mass, and particularly preferably 1 part by mass to 20 parts by mass, with respect to 100 parts by mass of water included in the aqueous solution.

As the oxidizing agent, one kind may be used alone or two kinds or more may be used.

In a case where the aqueous solution contains a catalyst, a content of the oxidizing agent is preferably 0.005 parts by mass to 2 parts by mass, more preferably 0.01 parts by mass to 2 parts by mass, and still more preferably 0.1 parts by mass to 2 parts by mass, with respect to 100 parts by mass of water included in the aqueous solution.

As the catalyst, one kind may be used alone or two kinds or more may be used.

The aqueous solution preferably contains an alkaline compound other than the above-described components to adjust pH of the aqueous solution.

Examples of the alkaline compound include an inorganic base, such as alkali metal hydroxide (sodium hydroxide and the like) and alkali earth metal hydroxide; and an organic base. The alkaline compound is preferably alkali metal hydroxide among the compounds.

A content of the alkaline compound in the aqueous solution may be appropriately adjusted such that pH of the aqueous solution can be adjusted to a desired temperature, and is, for example, preferably 0.1 parts by mass to 10 parts by mass with respect to 100 parts by mass of water included in the aqueous solution.

The production method of the liquid crystal polymer particles with the surface subjected to the oxidation treatment may include other steps.

The production method of the liquid crystal polymer particles with the surface subjected to the oxidation treatment preferably includes a step of preparing the liquid crystal polymer particles for use in the oxidation treatment step.

The liquid crystal polymer particles for use in the oxidation treatment step may be produced by a known method or a commercial product may be used.

The production method of the liquid crystal polymer particles with the surface subjected to the oxidation treatment may include a washing step of washing the particles obtained through the oxidation treatment step, a drying step of drying the particles obtained through the oxidation treatment step or the washing step, and the like.

A washing method in the washing step and a drying method in the drying step are not particularly limited, and known methods can be used.

The liquid crystal polymer particles with the surface subjected to the oxidation treatment may contain other additives.

As other additives, known additives can be used. Specifically, examples of the additives include a filler, a leveling agent, an antifoaming agent, an antioxidant, an ultraviolet absorbent, a flame retardant, and a colorant.

As other additives, resin other than the above-described components may be included.

Examples of resin other than the liquid crystal polymer include thermoplastic resin, such as polyolefin, a cycloolefin polymer, polyamide, polyester, polyether ketone, polycarbonate, polyphenylene ether and a modified substance thereof, and polyether imide; an elastomer, such as a copolymer of glycidyl methacrylate and polyethylene; and thermocurable resin, such as phenol resin, epoxy resin, polyimide resin, or cyanate resin.

A total content of other additives is preferably equal to or less than 25 parts by mass, more preferably equal to or less than 10 parts by mass, and still more preferably equal to or less than 5 parts by mass, with respect to 100 parts by mass of the content of the liquid crystal polymer.

As the liquid crystal polymer particles with the surface subjected to the oxidation treatment, one kind may be used alone or two kinds or more may be used.

In a case where the film includes the filler, a content of the filler is preferably 20% by volume to 80% by volume, and more preferably 40% by volume to 80% by volume, with respect to the total volume of the film.

The film of the present disclosure may contain other components other than aromatic polyester amide and the filler as long as the effects of the present disclosure are not significantly impaired.

As other components, known additives can be used. Examples of other components include a leveling agent, an antifoaming agent, an antioxidant, an ultraviolet absorbent, a flame retardant, and a colorant.

Physical Property

Melting Calorie A melting calorie of the film of the present disclosure is equal to or greater than 0.5 J/g, preferably equal to or greater than 2.2 J/g, more preferably equal to or greater than 4.0 J/g, and still more preferably equal to or greater than 7.0 J/g. An upper limit value of the melting calorie is not particularly limited, and is, for example, 10.0 J/g.

In the present disclosure, the melting calorie indicates a calorie (latent heat) necessary for phase transition of a solid film to a liquid, and is a value that is measured using a differential scanning calorimeter. For example, the melting calorie is measured using “DSC-60A Plus” (manufactured by Shimadzu Corporation). A temperature increase rate in the measurement is set to 10° C./minute.

The film of the present disclosure has a high degree of crystallinity and a low dielectric loss tangent since the melting calorie is equal to or greater than 0.5 J/g.

The melting calorie of the film of the present disclosure can be controlled by appropriately selecting conditions, such as a temperature and a time during heating, and a temperature decrease rate during cooling.

Melting Point

A melting point of the film of the present disclosure is preferably 300° C. to 360° C., and more preferably 320° C. to 350° C.

In the present disclosure, the melting point is a value that is measured using a differential scanning calorimeter. As the differential scanning calorimeter, for example, “DSC-60A Plus” (manufactured by Shimadzu Corporation) can be used. A temperature increase rate in the measurement is set to 10° C./minute.

Ratio of Melting Calorie to Melting Point

From a viewpoint of further decreasing the dielectric loss tangent, in the film the present disclosure, a ratio of the melting calorie to the melting point is preferably equal to or greater than 0.007 J/g ° C. An upper limit value of the ratio is not particularly limited, and is, for example, equal to or greater than 0.02 J/g ° C.

Dielectric Loss Tangent

The dielectric loss tangent of the film of the present disclosure is preferably equal to or less than 0.005, more preferably equal to or less than 0.004, and still more preferably equal to or less than 0.003.

In the present disclosure, the measurement of the dielectric loss tangent is performed by a resonance perturbation method at a frequency of 10 GHz. A 10 GHz cavity resonator (CP531 manufactured by KANTO Electronic Application and Development Inc.) is connected to a network analyzer (“E8363B” manufactured by Agilent Technology Co., Ltd.), a test piece is inserted into the cavity resonator, and the dielectric loss tangent of the film is measured from change in resonance frequency before and after insertion for 96 hours under an environment of a temperature of 25° C. and humidity of 60% RH.

Thickness

A thickness of the film of the present disclosure is preferably 6 μm to 200 μm, more preferably 12 μm to 100 μm, and still more preferably 20 μm to 60 μm from a viewpoint of strength, the dielectric loss tangent, and adhesiveness to a metal layer.

The thickness of the film is measured at any five places using an adhesive film thickness meter. The measurement is performed, for example, using an electronic micrometer (product name “KG3001A”, manufactured by Anritsu Corporation) as a film thickness meter, and an average value of the measured values is employed.

Manufacturing Method of Film

The film of the present disclosure can be manufactured by a known method. For example, a resin solution or a resin dispersion liquid including aromatic polyester amide is coated on a substrate by a casting method to form a resin layer, and then, the substrate is peeled, whereby the resin layer can be obtained as a film. A metal substrate is used as the substrate, whereby a laminate having a metal layer and the resin layer (film) can be obtained. The substrate may not be peeled depending on purposes.

The resin solution preferably contains aromatic polyester amide and a solvent. The resin dispersion liquid preferably contains aromatic polyester amide, a filler, and a solvent.

Examples of the solvent include halogenated hydrocarbon, such as dichloromethane, chloroform, 1,1-dichloroethane, 1,2-dichloroethane, 1,1,2,2-tetrachloroethane, 1-chlorobutane, chlorobenzene, or o-dichlorobenzene; halogenated phenol, such as p-chlorophenol, pentachlorophenol, or pentafluorophenol; ether, such as diethyl ether, tetrahydrofuran, or 1,4-dioxane; ketone, such as acetone or cyclohexanone; ester, such as ethyl acetate or γ-butyrolactone; carbonate, such as ethylene carbonate or propylene carbonate; amine, such as triethylamine; a nitrogen-containing heterocyclic aromatic compound, such as pyridine; nitrile, such as acetonitrile or succinonitrile; amide, such as N,N-dimethylformamide, N,N-dimethylacetamide, or N-methylpyrrolidone; a urea compound, such as tetramethylurea; a nitro compound, such as nitromethane or nitrobenzene; a sulfur compound, such as dimethyl sulfoxide or sulfolane; and phosphorus compound, such as hexamethylphosphoramide or tri-n-butyl phosphate.

The solvent preferably contains an aprotic compound, and in particular, an aprotic compound having no halogen atom among the solvents for low corrosiveness and easiness to handle. A proportion of the aprotic compound to the whole solvent is preferably 50% by mass to 100% by mass, more preferably 70% by mass to 100% by mass, and particularly preferably 90% by mass to 100% by mass. For easiness to dissolve aromatic polyester amide, the aprotic compound is preferably amide, such as N,N-dimethylformamide, N,N-dimethylacetamide, or N-methylpyrrolidone, or ester, such as γ-butyrolactone, and more preferably N,N-dimethylformamide, N,N-dimethylacetamide, or N-methylpyrrolidone.

After the resin solution or the resin dispersion liquid is coated on the substrate, heating is preferably performed. A heating temperature is, for example, 40° C. to 100° C. A heating time is, for example, 10 minutes to 5 hours.

After the resin layer is formed on the substrate, and annealing treatment is preferably performed on a laminate including the substrate and the resin layer. The melting calorie of the film can be adjusted by a temperature and a time of the annealing treatment. To set the melting calorie of the film to be equal to or greater than 2.2 J/g, the annealing treatment is preferably performed at 250° C. to 350° C. for 2.5 hours to 10 hours. The annealing treatment is preferably performed under an inert gas atmosphere, such as nitrogen.

Laminate

The laminate of the present disclosure preferably includes the film, and a metal layer or a metal wire disposed on at least one surface of the film.

The metal layer or the metal wire may be a known metal layer or metal wire, and examples of metal include copper, silver, gold, and an alloy thereof. The metal layer or the metal wire is preferably a copper layer or a copper wire.

The copper layer is preferably a rolled copper foil formed by a rolling method or an electrolytic copper foil formed by an electrolytic method.

The laminate may be manufactured by laminating the film and the metal layer.

As a method for laminating the film and the metal layer is not particularly limited, and a known laminating method can be used.

The metal substrate is used as the substrate in the manufacturing method of the film, whereby the laminate can be manufactured without peeling the film from the substrate.

A thickness of the metal layer is not particularly limited, and is preferably 3 μm to 30 μm, and more preferably 5 μm to 20 μm.

The thickness of the metal layer is calculated by the following method.

The laminate is cut with a microtome, and a cross section is observed with an optical microscope. Three or more cross section samples are cut, and a thickness of a layer to be measured in each cross section is measured at three points or more. An average value of the measured values is calculated, and an average thickness is employed.

The metal layer in the laminate of the present disclosure is, for example, preferably processed in a desired circuit pattern by etching to form a flexible printed circuit board. An etching method is not particularly limited, and a known etching method can be used.

### Examples

Hereinafter, while the present disclosure will be more specifically described by examples, the present disclosure is not limited to the following examples within a range departing from the gist thereof.

Synthesis of Aromatic Polyester Amide A1

940.9 g (5.0 mol) of 6-hydroxy-2-naphthoic acid, 377.9 g (2.5 mol) of acetaminophen, 415.3 g (2.5 mol) of isophthalic acid, and 867.8 g (8.4 mol) of acetic anhydride are put in a reactor comprising a stirring device, a torque meter, a nitrogen gas introduction pipe, a thermometer, and a reflux condenser, gas in the reactor is substituted with nitrogen gas, a temperature increases from a room temperature (23° C., the same applies hereinafter) to 143° C. over 60 minutes while stirring under a nitrogen gas flow, and refluxing is performed at 143° C. for one hour.

Next, the temperature increases from 150° C. to 300° C. over five hours while by-produced acetic acid and unreacted acetic anhydride are distilled and is maintained at 300° C. for 30 minutes. Thereafter, a content is taken out from the reactor and is cooled to the room temperature. An obtained solid is ground by a grinder, and powdered aromatic polyester amide A1a is obtained. Aromatic polyester amide Ala is fully aromatic polyester amide.

Aromatic polyester amide Ala is subjected to solid polymerization by increasing the temperature from the room temperature to 160° C. over two hours and 20 minutes, next increasing the temperature from 160° C. to 180° C. over three hours and 20 minutes, and maintaining the temperature at 180° C. for five hours under a nitrogen atmosphere, then, is cooled, and next, is ground by the grinder, and powdered aromatic polyester amide Alb is obtained.

Aromatic polyester amide Alb is subjected to solid polymerization by increasing the temperature from the room temperature to 180° C. over one hour and 20 minutes, next increasing the temperature from 180° C. to 240° C. over five hours, and maintaining the temperature at 240° C. for five hours under the nitrogen atmosphere, and then, is cooled, and aromatic polyester amide A1 is obtained.

Solubility of aromatic polyester amide A1 with respect to N-methylpyrrolidone at 140° C. is equal to or greater than 1% by mass.

Synthesis of Aromatic Polyester Amide A2

941 g (5.0 mol) of 6-hydroxy-2-naphthoic acid, 273 g (2.5 mol) of 4-aminophenol, 415 g (2.5 mol) of isophthalic acid, and 1123 g (11 mol) of acetic anhydride are put in a reactor comprising a stirring device, a torque meter, a nitrogen gas introduction pipe, a thermometer, and a reflux condenser, gas in the reactor is substituted with nitrogen gas, a temperature increases from a room temperature to 150° C. over 15 minutes while stirring under a nitrogen gas flow, and refluxing is performed at 150° C. for three hours.

Next, the temperature increases from 150° C. to 320° C. over three hours while by-produced acetic acid and unreacted acetic anhydride are distilled and is maintained until an increase in viscosity is recognized. Thereafter, a content is taken out from the reactor and is cooled to the room temperature. An obtained solid is ground by a grinder, and powdered aromatic polyester amide A2a is obtained.

Aromatic polyester amide A2a is subjected to solid polymerization by maintaining the temperature at 250° C. for three hours under a nitrogen atmosphere, then, is cooled, and next, is ground by the grinder, and powdered aromatic polyester amide A2 is obtained.

Solubility of aromatic polyester amide A2 with respect to N-methylpyrrolidone at 140° C. is equal to or greater than 1% by mass.

Preparation of Filler
liquid crystal polymer particles (LCP particles) B1
liquid crystal polymer particles (LCP particles) B2
silica particles . . . product name “HARIMIC CR10-20”, manufactured by NIPPON STEEL Chemical & Material Co., Ltd., average particle diameter (D50) 10 μm
hollow particles . . . product name “glass bubbles S60HS”, manufactured by 3M Japan Limited, average particle diameter (D50) 30 μm

The LCP particles B1 and the LCP particles B2 are produced by the following method.

LCP Particles B1

1034.99 g (5.5 mol) of 2-hydroxy-6-naphthoic acid, 3012.05 g (21.8 mol) of 4-hydroxybenzoic acid, 13.71 g (0.08 mol) of terephthalic acid, and acetic anhydride and a metal catalyst as a catalyst are put in a reactor comprising a stirring device, a torque meter, a nitrogen gas introduction pipe, a thermometer, and a reflux condenser. Gas in the reactor is substituted with nitrogen gas, then, a temperature increases from a room temperature to 140° C. over 15 minutes while stirring under a nitrogen gas flow, and refluxing is performed at 140° C. for one hour.

Next, the temperature increases from 150° C. to 330° C. over three hours and 30 minutes, then, pressure reduction is performed, and polymerization is performed while by-produced acetic acid and unreacted acetic anhydride are distilled. After polymerization, cooling is performed at the room temperature, and a liquid crystal polymer B1a is obtained.

The liquid crystal polymer B1a is ground using a jet mill (“KJ-200” manufactured by KURIMOTO Ltd.), and liquid crystal polymer particles B1b are obtained.

The liquid crystal polymer particles B1b: 50 parts by mass are added to a sodium hydroxide aqueous solution (NaOH: 40 parts by mass/water: 400 parts by mass) and stirring is performed. A sodium persulfate aqueous solution (sodium persulfate: 9.6 parts by mass/water: 100 parts by mass) is added, a temperature increases to 50° C., and stirring is further performed for three hours. The solution is cooled to the room temperature, and then, is filtered. After washing with 500 parts by mass of water, the solution is sufficiently dried at 40° C., and LCP particles B1 are obtained. The LCP particles B1 are liquid crystal polymer particles with a surface subjected to oxidation treatment. The LCP particles B1 have a median diameter (D50) of 15 μm, a dielectric loss tangent of 0.0014, and a melting point of 318° C.

LCP Particles B2

1034.99 g (5.5 mol) of 2-hydroxy-6-naphthoic acid, 89.18 g (0.41 mol) of 2,6-naphthalenedicarboxylic acid, 236.06 g (1.42 mol) of terephthalic acid, 341.39 g (1.83 mol) of 4,4-dihydroxybiphenyl, and potassium acetate and magnesium acetate as a catalyst are put in a reactor comprising a stirring device, a torque meter, a nitrogen gas introduction pipe, a thermometer, and a reflux condenser. Gas in the reactor is substituted with nitrogen gas, and then, acetic anhydride (1.08 molar equivalent with respect to a hydroxyl group) is further added. A temperature increases from a room temperature to 150° C. over 15 minutes while stirring under a nitrogen gas flow, and refluxing is performed at 150° C. for two hours.

Next, the temperature increases from 150° C. to 310° C. over five hours while by-produced acetic acid and unreacted acetic anhydride are distilled, and a polymerized substance is taken out and is cooled to the room temperature. An obtained polymerized substance increases in temperature from the room temperature to 295° C. over 14 hours, and is subjected to solid polymerization at 295° C. for one hour. After solid polymerization, cooling is performed to the room temperature over five hours, and a liquid crystal polymer B2a is obtained.

The liquid crystalline polyester B2a is ground using a jet mill (“KJ-200” manufactured by KURIMOTO Ltd.), and liquid crystal polymer particles B2b are obtained.

The liquid crystal polymer particles B2b: 50 parts by mass are added to a sodium hydroxide aqueous solution (NaOH: 40 parts by mass/water: 400 parts by mass) and stirring is performed. A sodium persulfate aqueous solution (sodium persulfate: 9.6 parts by mass/water: 100 parts by mass) is added, a temperature increases to 50° C., and stirring is further performed for three hours. The solution is cooled to the room temperature, and then, is filtered. After washing with 500 parts by mass of water, the solution is sufficiently dried at 40° C., and LCP particles B2 are obtained. The LCP particles B2 are liquid crystal polymer particles with a surface subjected to oxidation treatment. The LCP particles B2 have a median diameter (D50) of 10 μm, a dielectric loss tangent of 0.0007, and a melting point of 334° C.

Production of Copper-Clad Laminate

Aromatic polyester amide (80 g) described in Table 1 is added to 920 g of N-methylpyrrolidone, and stirring is performed at 140° C. for four hours under a nitrogen atmosphere. A resin solution in which a concentration of solid contents is 8.0% by mass is obtained.

A filler described in Table 1 is mixed with the resin solution as a content described in Table 1, and is dispersed for 15 minutes using an ultrasound disperser, and a resin dispersion liquid is obtained.

The resin solution or the resin dispersion liquid is coated on an electrolytic copper foil (product name “CF-T9DA-SV-18”, manufactured by FUKUDA Metal Foil & Powder Co., Ltd., surface roughness Sa=0.22 μm), and is dried at 50° C. for three hours. With this, a resin layer having a thickness of 40 μm is formed on the electrolytic copper foil.

Annealing treatment is performed on a laminate in which the resin layer is formed on the electrolytic copper foil, based on a temperature and a time described in Table 1 in a nitrogen atmosphere, and a copper-clad laminate (laminate) is obtained.

A copper layer is etched from the produced flexible copper-clad laminate to take out a film. A strip-shaped test piece having a width of 2 cm and a length of 8 cm is cut from the taken-out film. A melting calorie, a melting point, breaking elongation, and a dielectric loss tangent of the film are measured using the test piece. A measurement method is as follows. A measurement result is shown in Table 1.

Melting Calorie and Melting Point

The melting calorie and the melting point are measured using a differential scanning calorimeter (product name “DSC-60 Plus”, manufactured by Shimadzu Corporation). A temperature increase rate in the measurement is set to 10° C./minute.

Breaking Elongation

A universal tensile testing instrument “STM T50BP” manufactured by Toyo Baldwin Co., Ltd. is used to measure stress with respect to an elongation at a tensile speed of 10%/minute in an atmosphere of 25° C. and 60% RH, and breaking strength is obtained.

Dielectric Loss Tangent

A measurement of the dielectric loss tangent is performed by a resonance perturbation method at a frequency of 10 GHz. A 10 GHz cavity resonator (CP531 manufactured by KANTO Electronic Application and Development Inc.) is connected to a network analyzer (“E8363B” manufactured by Agilent Technology Co., Ltd.), the test piece is inserted into the cavity resonator, and the dielectric loss tangent of the film is measured from change in resonance frequency before and after insertion for 96 hours under an environment of a temperature of 25° C. and humidity of 60% RH.

TABLE 1

| | | Filler | | | | | | | |
|---|---|---|---|---|---|---|---|---|---|
| | Aromatic | | Content | Annealing Treatment | | Melting | Melting | | Dielectric |
| | Polyester | | (% by | Temperature | Time | Calorie | Point | Breaking | Loss |
| | Amide | Kind | Volume) | (° C.) | (h) | (J/g) | (° C.) | Elongation | Tangent |
| Example 1 | A1 | LCP Particles | 50 | 300 | 3 | 7.25 | 345 | 35 | 0.0031 |
| | | B1 | | | | | | | |
| Example 2 | A2 | LCP particles | 50 | 300 | 3 | 6.90 | 350 | 30 | 0.0032 |
| | | B1 | | | | | | | |
| Example 3 | A1 | LCP particles | 25 | 300 | 3 | 7.68 | 348 | 20 | 0.0034 |
| | | B2 | | | | | | | |
| Example 4 | A1 | LCP particles | 50 | 300 | 3 | 8.10 | 351 | 40 | 0.0025 |
| | | B2 | | | | | | | |
| Example 5 | A1 | LCP particles | 75 | 300 | 3 | 8.52 | 354 | 34 | 0.0020 |
| | | B2 | | | | | | | |
| Example 6 | A1 | LCP particles | 85 | 300 | 3 | 8.95 | 357 | 18 | 0.0018 |
| | | B2 | | | | | | | |
| Example 7 | A1 | Silica | 50 | 300 | 3 | 3.00 | 320 | 28 | 0.0026 |
| | | Particles | | | | | | | |
| Example 8 | A1 | Silica | 85 | 300 | 3 | 0.70 | 320 | 19 | 0.0017 |
| | | Particles | | | | | | | |
| Example 9 | A1 | Hollow | 50 | 300 | 3 | 2.80 | 330 | 30 | 0.0036 |
| | | Particles | | | | | | | |
| Comparative | A1 | — | — | 270 | 2 | 2.1 | 318 | 14 | 0.0060 |
| Example 1 | | | | | | | | | |
| Comparative | A1 | Silica | 85 | 260 | 2 | 0.4 | 317 | 5 | 0.0062 |
| Example 2 | | Particles | | | | | | | |

As shown in Table 1, in Example 1 to Example 9, since the film includes the liquid crystal polymer and the filler, and the melting calorie is equal to or greater than 0.5 J/g, the film is excellent in strength and has a low dielectric loss tangent.

On the other hand, in Comparative Example 1, no filler is included in the film, and the film is inferior in strength and has a high dielectric loss tangent.

In Comparative Example 2, the melting calorie of the film is less than 0.5 J/g, and the film is inferior in strength and has a high dielectric loss tangent.

What is claimed is:

1. A film comprising a liquid crystal polymer; and a filler,
the film having a melting calorie equal to or greater than 0.5 J/g.

2. The film according to claim 1,
wherein the liquid crystal polymer comprises an aromatic polyester amide.

3. The film according to claim 2, wherein:
the aromatic polyester amide comprises a unit represented by the following Formula 1, a unit represented by the following Formula 2, and a unit represented by the following Formula 3; and
with respect to a total content of the unit represented by Formula 1, the unit represented by Formula 2, and the unit represented by Formula 3,
a content of the unit represented by Formula 1 is 30% by mol to 80% by mol,
a content of the unit represented by Formula 2 is 10% by mol to 35% by mol, and
a content of the unit represented by Formula 3 is 10% by mol to 35% by mol,
—O—Ar¹—CO— Formula 1
—CO—Ar²—CO— Formula 2
—NH—Ar³—O— Formula 3
wherein in Formulae 1 to 3, Ar′, Ar^{e}, and Ar^{a} each independently represent a phenylene group, a naphthylene group, or a biphenylylene group.

4. The film according to claim 1,
wherein the filler includes an inorganic filler comprising at least one selected from the group consisting of boron nitride, titanium dioxide, and silicon dioxide.

5. The film according to claim 1,
wherein the filler includes an organic filler comprising at least one selected from the group consisting of liquid crystalline polyester, polytetrafluoroethylene, and polyethylene.

6. The film according to claim 1,
wherein the filler comprises hollow particles.

7. The film according to claim 1,
wherein the filler comprises liquid crystal polymer particles, silica particles, or glass hollow particles.

8. The film according to claim 7,
wherein the liquid crystal polymer particles include liquid crystal polymer particles with a surface subjected to oxidation treatment.

9. The film according to claim 1,
wherein a content of the filler is 30% by volume to 80% by volume with respect to a total volume of the film.

10. A laminate comprising:
the film according to claim 1; and
a metal layer or a metal wire that is disposed on at least one surface of the film.
